(19) United States
(12) Patent Application Publication
(10) Pub. No.: US 2025/0249975 A1
(43) Pub. Date: Aug. 7, 2025

(54) BRAKE PAD ASSEMBLY FOR A BICYCLE

(71) Applicant: Nucap Industries Inc., Scarborough (CA)

(72) Inventor: Ian Bradley CURRINS, Lindsay (CA)

(21) Appl. No.: 18/857,096

(22) PCT Filed: Jan. 17, 2023
(86) PCT No.: PCT/CA2023/050042

§ 371 Date: Oct. 15, 2024

Related U.S. Application Data
(60) Provisional application No. 63/330,896, filed on Apr. 14, 2022.

(51) Int. Cl. B62L 1/00; F16D 65/097; F16D 69/04; F16D 127/02

(52) U.S. Cl. CPC B62L 1/005; F16D 65/0979; F16D 69/0408; F16D 2069/0441; F16D 2127/02; F16D 2200/0004; F16D 2250/0007; F16D 2250/0023; F16D 2250/0061; F16D 2250/0084

(57) ABSTRACT

A brake pad assembly for a bicycle includes a spreader spring, and a pair of friction pads. The spreader spring has a first leaf, a second leaf, and a spring joint joining the first leaf and the second leaf together. The spreader spring is biased towards a spread position in which the first leaf and second leaf are spaced apart from each other, and is moveable to a compressed position in which the first leaf and the second leaf are moved towards each other relative to the spread position. Each leaf has a rotor facing surface, and each leaf has a set of grooves gouged into the rotor facing surface to yield a corresponding set of barbs extending from the rotor facing surface. The friction pads are secured to the rotor facing surfaces via the barbs, which are embedded in friction pads.

### FIELD

This document relates to disc brakes for bicycles. More specifically, this document relates to brake pad assemblies for bicycle disc brakes, spreader springs for such brake pad assemblies, and methods for assembling such brake pad assemblies.

### BACKGROUND

U.S. Patent Application Publication No. US2021/0179228 A1 (Arbesman) discloses a brake pad assembly for a bicycle. The brake pad assembly includes a first brake pad, a second brake pad, and a spreader spring. The first brake pad has a first backing plate with a first rotor facing surface, and a first friction pad secured to the rotor facing surface. The second brake pad has a second backing plate with a second rotor facing surface, and a second friction pad secured to the second rotor facing surface and facing the first friction pad. The spreader spring has a first leaf that is fixed to the first brake pad and a second leaf that is fixed to the second brake pad. At least a portion of the first leaf is positioned between the first rotor facing surface and the first friction pad, and at least a portion of the second leaf is positioned between the second rotor facing surface and the second friction pad.

### SUMMARY

The following summary is intended to introduce the reader to various aspects of the detailed description, but not to define or delimit any invention.

Brake pad assemblies for bicycles are disclosed. According to some aspects, a brake pad assembly for a bicycle includes a one-piece spreader spring having a first leaf, a second leaf, and a spring joint joining the first leaf and the second leaf together. The spreader spring is biased towards a spread position in which the first leaf and second leaf are spaced apart from each other, and is moveable to a compressed position in which the first leaf and the second leaf are moved towards each other relative to the spread position. Each leaf has a respective rotor facing surface, and each leaf has a set of grooves gouged into the rotor facing surface to yield a corresponding set of barbs extending from the rotor facing surface. The brake pad assembly further includes a first friction pad and a second friction pad. The barbs of the first leaf are embedded in the first friction pad to secure the first friction pad to the first leaf. The barbs of the second leaf are embedded in the second friction pad to secure the second friction pad to the second leaf.

Preferably, the brake pad assembly does not include any separately formed brake pad backing plates.

The first friction pad can be molded on to the rotor facing surface of the first leaf, and the second friction pad can be molded on to the rotor facing surface of the second leaf. Alternatively, the first friction pad can be impaled onto the barbs of the first leaf, and the second friction pad can be impaled onto the barbs of the second leaf.

The first leaf and the second leaf each can each include a respective through hole, and the through holes can be aligned for receipt of a pin.

The spreader spring can be a one-piece stamping.

The first leaf and the second leaf can each have a respective caliper-facing surface opposite the respective rotor facing surface, and the first leaf and the second leaf can each have a respective thickness between the respective caliper-facing surface and the respective rotor facing surface. Each respective thickness can be between about 0.02 inches and 0.04 inches.

Each barb can have a height between the rotor facing surface and a tip thereof. An average height of the barbs can be between about 0.02 inches and 0.03 inches.

The first friction pad and the second friction pad can each have a respective thickness, and the thickness can be between about 0.05 inches and about 0.15 inches.

The first leaf and the second leaf can each have a respective caliper-facing surface opposite the rotor facing surface thereof, and in use, the caliper-facing surface of the first leaf and the caliper facing surface of the second leaf can directly engage with a brake caliper.

Spreader springs for bicycle brake pad assemblies are disclosed. According to some aspects, a spreader spring for a brake pad assembly for a bicycle includes a one piece stamping having a first leaf, a second leaf, and a spring joint joining the first leaf and the second leaf together. The spreader spring is biased towards a spread position in which the first leaf and second leaf are spaced apart from each other, and is moveable to a compressed position in which the first leaf and the second leaf are moved towards each other relative to the spread position. Each leaf has a respective rotor facing surface, and each leaf includes a set of grooves gouged into the rotor facing surface to yield a corresponding set of barbs extending from the rotor facing surface.

The first leaf and the second leaf can each include a respective through hole, and the through holes can be aligned for receipt of a pin.

The first leaf and the second leaf can each have a respective caliper-facing surface opposite the respective rotor facing surface, and the first leaf and the second leaf can each have a respective thickness between the respective caliper-facing surface and the respective rotor facing surface. Each respective thickness can be between about 0.02 inches and 0.04 inches.

Each barb can have a height between the rotor facing surface and a tip thereof, and an average height of the barbs can be between about 0.02 inches and 0.03 inches.

The first leaf and the second leaf can each have a respective caliper-facing surface opposite the rotor facing surface thereof, and in use, the caliper-facing surface of the first leaf and the caliper facing surface of the second leaf can directly engage with a brake caliper.

Methods for assembling bicycle brake pad assemblies are also disclosed. According to some aspects, a method for assembling a brake pad assembly for a bicycle includes: a) securing a first friction pad to a rotor facing surface of a first leaf of a spreader spring by embedding barbs of the first leaf in the first friction pad; and b) securing a second friction pad to a rotor facing surface of a second leaf of a spreader spring by embedding barbs of the second leaf in the second friction pad.

Step a) can include impaling the first friction pad on the barbs of the first leaf, and step b) can include impaling the second friction pad on the barbs of the second leaf. Alternatively, step a) can include molding the first friction pad onto the barbs of the first leaf, and step b) can include molding the second friction pad on to the barbs of the second leaf.

Steps a) and b) are preferably carried out in the absence of any separately formed brake pad backing plates.

Prior to step a), the method can further include stamping a spreader spring blank from a sheet of metal; gouging the spreader spring blank to form the barbs of the first leaf and the barbs of the second leaf; and bending the spreader spring blank to form the spreader spring.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a perspective view of an example brake pad assembly for a bicycle, including a one-piece spreader spring and first and second friction pads;

FIG. 2 is a partial cross-section of the brake pad assembly of FIG. 1, taken through the spreader spring and first friction pad;

FIG. 3 is a perspective view of the spreader spring of the brake pad assembly of FIG. 1;

FIG. 4 is an enlarged view of a portion of the spreader spring of FIG. 3; and

FIG. 5 is an enlarged side view of a portion of the spreader spring of FIG. 3.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Terms of degree such as “substantially”, “about”, and “approximately” as used herein mean a reasonable amount of deviation of the modified term such that the end result is not significantly changed. These terms of degree may also be construed as including a deviation of the modified term if this deviation would not negate the meaning of the term it modifies.

Generally disclosed herein are brake pad assemblies for bicycles, and particularly for use in bicycle disc brakes. The brake pad assemblies can generally include a one-piece spreader spring (e.g. a sheet metal stamping formed into a spreader spring) that includes a pair of leaves that are joined together at a spring joint. A respective friction pad is secured directly to each leaf. Notably, the assemblies can omit include any separately formed brake pad backing plates. That is, in the brake pad assemblies disclosed herein, the leaves themselves serve the function of brake pad backing plates, such that traditional brake pad backing plates can be omitted. This in turn results in a brake pad assembly that is lighter and simpler to manufacture.

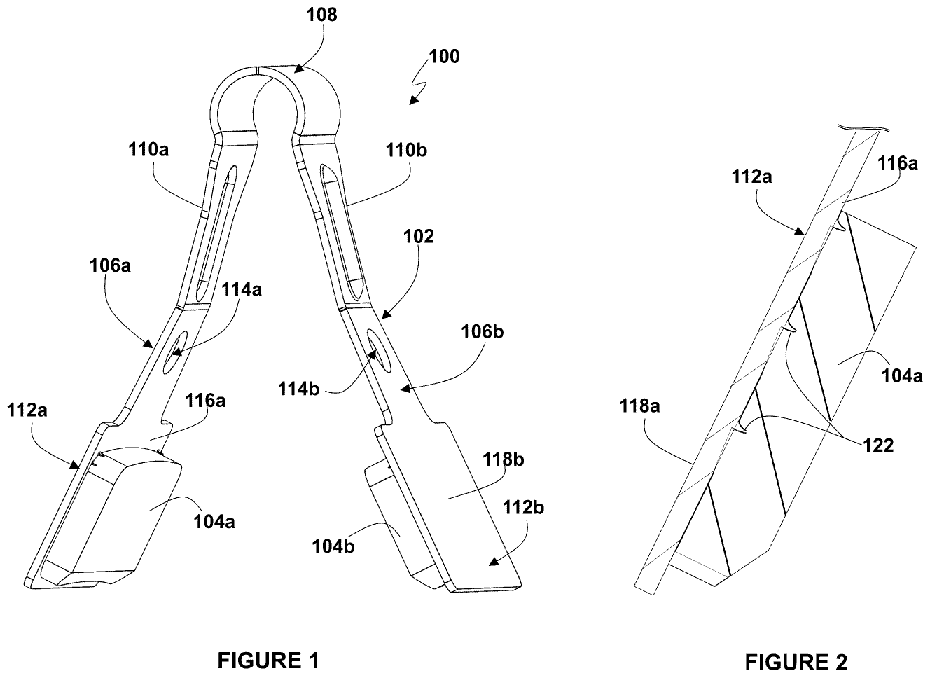

Referring now to FIGS. 1 and 2, an example brake pad assembly 100 is shown. The brake pad assembly 100 generally includes a spreader spring 102, and a pair of friction pads 104a, 104b (also referred to herein as a first friction pad 104a and a second friction pad 104b). The first friction pad 104a and second friction pad 104b face each other, so that in use, upon application of a braking force (e.g. by the squeezing of hand brakes, which in turn actuates a brake caliper in which the brake pad assembly is mounted), the friction pads 104a, 104b are compressed towards each other to squeeze a rotor of the bicycle (not shown). The spreader spring 102 functions to spread the friction pads 104a, 104b apart from the rotor after the braking force is released. Particularly, the spreader spring 102 is biased towards a spread position, shown in FIG. 1, in which the first brake pad 104a and second brake pad 104b are spaced apart from each other. The spreader spring 102 is moveable to a compressed position (not shown) in which the first brake pad 104a and the second brake pad 104b are moved towards each other relative to the spread position.

The friction pads 104a, 104b may be made from any suitable friction material, such as resin with various additives and fillers. As will be described in further detail below, the friction pads 104a, 104b may optionally be pre-formed and secured to spreader spring 102 (e.g. by impaling the pre-formed friction pads 104a, 104b on barbs of spreader spring 102), or may be formed directly onto the spreader spring 102 (e.g. by moulding the friction pads 104a, 104b onto barbs of the spreader spring 102).

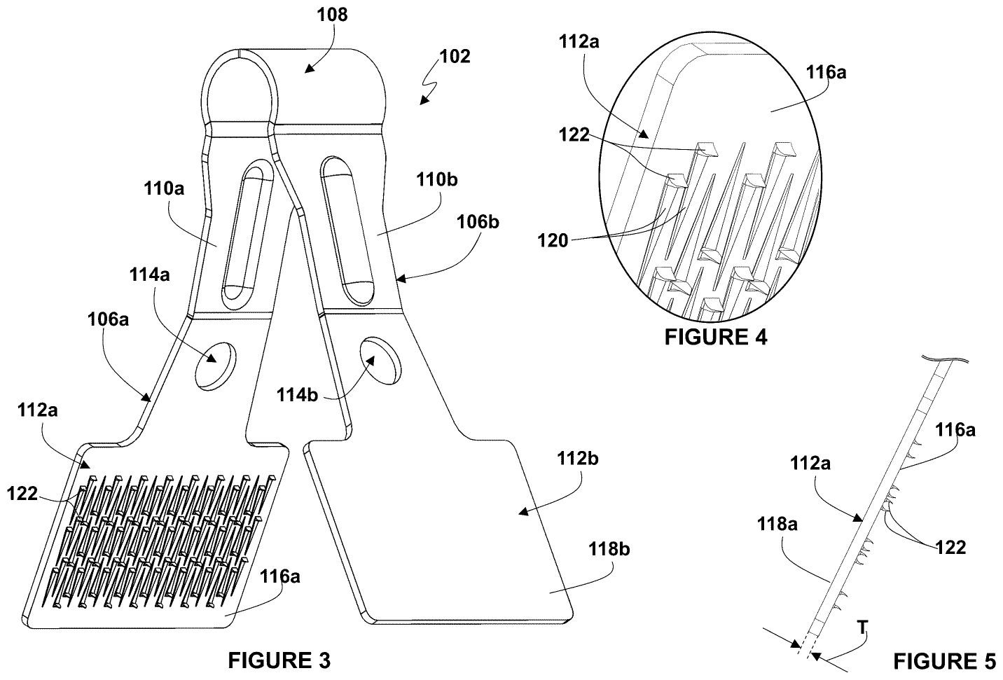

Referring to FIG. 3, the spreader spring 102 is shown in isolation. In the example shown, the spreader spring 102 includes a pair of leaves 106a, 106b (also referred to herein as a first leaf 106a and a second leaf 106b). The first leaf 106a and the second leaf 106b are joined together at a spring joint 108, which is generally U-shaped and is resiliently flexible. The spreader spring 102 is a one-piece spreader spring. That is, the leaves 106a, 106b and the spring joint 108 are integrally formed from a single piece of material. For example, the spreader spring 102 may be in the form of a stamping. Particularly, the spreader spring 102 may be formed by stamping a piece of sheet metal to form a spreader spring blank (not shown), gouging the spreader spring blank to form barbs thereon (as described below), then bending the spreader spring blank to form the leaves 106a, 106b and spring joint 108.

Referring still to FIG. 3, the first leaf 106a has an arm 110a, and a friction pad supporting section 112a at the end of the arm 110a. Likewise, the second leaf 106b has an arm 110b, and a friction pad supporting section 112b at the end of the arm 110b. The friction pad supporting sections 112a, 112b are generally rectangular; however, other shapes are possible. The arms 110a, 110b each include a respective through-hole 114a, 114b. The through holes 114a, 114b are aligned so a pin (not shown) may be inserted through the through holes 114a, 114b to mount the brake pad assembly 100 in a brake caliper.

Referring to FIGS. 4 and 5, the friction pad supporting section 112a of the first leaf 106a is shown in greater detail. The friction pad supporting section 112b of the second leaf 106b is generally the same as the friction pad supporting section 112a of the first leaf 106a, and for brevity, is not shown. The friction pad supporting section 112a has a rotor facing surface 116a and a caliper facing surface 118a opposite the rotor facing surface 116a. In use, the caliper facing surface 118a may engage directly with a brake caliper. That is, as described above, other pieces or parts, such as a traditional brake pad backing plate, are preferably not positioned between the friction pad supporting section 112a and the brake caliper.

Referring still to FIG. 5, the friction pad supporting section 112a may be relatively thin. For example, the thickness T between the rotor facing surface 116a and the caliper facing surface 118a may be between about 0.02 inches and 0.04 inches (e.g. about 0.03 inches). As such, the spreader spring 102 may be relatively lightweight.

Referring to FIGS. 3 and 4, the friction pad supporting section 112a has a set of grooves 120 (only two of which are labelled) gouged into the rotor facing surface 116a, to yield a corresponding set of barbs 122 (only two of which are labelled) extending from the rotor-facing surface 116a. The gouging process may be that described in one or more of U.S. Pat. No. 9,463,502 (Arbesman) and U.S. Pat. No. 9,199,322 (Arbesman), both of which are incorporated herein by reference in their entirety. The barbs 122 may be of various sizes, and may be applied in various arrangements. For example, the barbs 122 may be arranged in rows. For further example, the average height of the barbs 122 (where height refers to the distance between the rotor facing surface 116a and the tip of the barb 122) may be, for example, between about 0.02 inches and 0.03 inches (e.g. about 0.025 inches).

Similarly to the first friction pad supporting section 112a, the second friction pad supporting section 112b has a rotor facing surface (not shown) and a caliper facing surface 118b opposite the rotor facing surface, and the second friction pad supporting section 112b has a set of grooves (not shown) gouged into the rotor facing surface, to yield a corresponding set of barbs (not shown) extending from the rotor-facing surface

Referring back to FIGS. 1 and 2, the first friction pad 104a is secured to the rotor facing surface 116a of the first leaf 106a, and the second friction pad 104b is secured to the rotor facing surface (not shown) of the second leaf 106b. Particularly, the barbs 122 of the first leaf 106a are embedded in the first friction pad 104a, to secure the first friction pad 104a to the first leaf 106a. Likewise, the barbs of the second leaf 106b are embedded in the second friction pad 104b to secure the second friction pad 104b to the second leaf 106b. For example, the first and second friction pads 104a, 104b may be molded onto rotor facing surfaces of the first and second leaves 106a, 106b, respectively. Alternatively, the first and second friction pads 104a, 104b may be pre-formed, and then impaled onto the barbs 122 of the rotor facing surfaces of the first and second leaves 106a, 106b, respectively. This can be done, for example, using a press.

In order to install the assembly 100, the assembly 100 may be inserted into a brake caliper. A pin or other fastener (not shown) can then be inserted through the through holes 114a, 114b of the spreader spring 102, in order to retain the assembly in position in the brake caliper. As stated above, on application of a braking force, the caliper may engage directly with the spreader spring 102, without a separately formed backing plate positioned between the spreader spring and the caliper.

The assembly 100 shown in FIGS. 1 to 5 is sized and shaped to fit a particular model of brake caliper. In alternative examples, brake pad assemblies may include various other sizes and shapes of brake pads.

In any of the above examples, a barrier layer may be applied to the spreader spring 102 to prevent direct metal-to-metal contact between the spreader spring 102 and the pin. This can prevent or mitigate noise generated by sliding of the metallic spreader spring 102 along the metallic pin. Example materials for the barrier layer include nylon, latex, rubberized materials, friction reducing polymers such as polytetrafluoroethylene (PTFE, Teflon®), silicone, graphite, lubricating paints (e.g. Molykote®), and/or an epoxies

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A brake pad assembly for a bicycle, comprising:
a one-piece spreader spring having a first leaf, a second leaf, and a spring joint joining the first leaf and the second leaf together, wherein the spreader spring is biased towards a spread position in which the first leaf and second leaf are spaced apart from each other, and is moveable to a compressed position in which the first leaf and the second leaf are moved towards each other relative to the spread position, wherein each leaf has a respective rotor facing surface, and wherein each leaf comprises a set of grooves gouged into the rotor facing surface to yield a corresponding set of barbs extending from the rotor facing surface;
a first friction pad, wherein the barbs of the first leaf are embedded in the first friction pad to secure the first friction pad to the first leaf; and
a second friction pad facing the first friction pad, wherein the barbs of the second leaf are embedded in the second friction pad to secure the second friction pad to the second leaf.

2. The brake pad assembly of claim 1, wherein the brake pad assembly does not include any separately formed brake pad backing plates.

3. The brake pad assembly of claim 1, wherein the first friction pad is molded on to the rotor facing surface of the first leaf, and the second friction pad is molded on to the rotor facing surface of the second leaf.

4. The brake pad assembly of claim 1, wherein the first friction pad is impaled onto the barbs of the first leaf, and the second friction pad is impaled onto the barbs of the second leaf.

5. The brake pad assembly of claim 1, wherein the first leaf and the second leaf each comprise a respective through hole, wherein the through holes are aligned for receipt of a pin.

6. The brake pad assembly of claim 1, wherein the spreader spring is a one-piece stamping.

7. The brake pad assembly of claim 1, wherein
the first leaf and the second leaf each have a respective caliper-facing surface opposite the respective rotor facing surface;
the first leaf and the second leaf each have a respective thickness between the respective caliper-facing surface and the respective rotor facing surface; and
each respective thickness is between about 0.02 inches and 0.04 inches.

8. The brake pad assembly of claim 6, wherein each barb has a height between the rotor facing surface and a tip thereof, and wherein an average height of the barbs is between about 0.02 inches and 0.03 inches.

9. The brake pad assembly of claim 7, wherein the first friction pad and the second friction pad each have a respective thickness, and wherein the thickness is between about 0.05 inches and about 0.15 inches.

10. The brake pad assembly of claim 1, wherein
the first leaf and the second leaf each have a respective caliper-facing surface opposite the rotor facing surface thereof, and
in use, the caliper-facing surface of the first leaf and the caliper facing surface of the second leaf directly engage with a brake caliper.

11. A spreader spring for a brake pad assembly for a bicycle, comprising:
a one piece stamping having a first leaf, a second leaf, and a spring joint joining the first leaf and the second leaf together,
wherein the spreader spring is biased towards a spread position in which the first leaf and second leaf are spaced apart from each other, and is moveable to a compressed position in which the first leaf and the second leaf are moved towards each other relative to the spread position,
wherein each leaf has a respective rotor facing surface, and
wherein each leaf comprises a set of grooves gouged into the rotor facing surface to yield a corresponding set of barbs extending from the rotor facing surface.

12. The spreader spring of claim 10, wherein the first leaf and the second leaf each comprise a respective through hole, wherein the through holes are aligned for receipt of a pin.

13. The spreader spring of claim 10, wherein
the first leaf and the second leaf each have a respective caliper-facing surface opposite the respective rotor facing surface;
the first leaf and the second leaf each have a respective thickness between the respective caliper-facing surface and the respective rotor facing surface; and
each respective thickness is between about 0.02 inches and 0.04 inches.

14. The spreader spring of claim 10, wherein each barb has a height between the rotor facing surface and a tip thereof, and wherein an average height of the barbs is between about 0.02 inches and 0.03 inches.

15. The spreader spring of claim 10, wherein
the first leaf and the second leaf each have a respective caliper-facing surface opposite the rotor facing surface thereof, and
in use, the caliper-facing surface of the first leaf and the caliper facing surface of the second leaf directly engage with a brake caliper.

16. A method for assembling a brake pad assembly for a bicycle, comprising:
a. securing a first friction pad to a rotor facing surface of a first leaf of a spreader spring by embedding barbs of the first leaf in the first friction pad; and
b. securing a second friction pad to a rotor facing surface of a second leaf of a spreader spring by embedding barbs of the second leaf in the second friction pad.

17. The method of claim 16, wherein step a. comprises impaling the first friction pad on the barbs of the first leaf, and step b. comprises impaling the second friction pad on the barbs of the second leaf.

18. The method of claim 16, wherein step a. comprises molding the first friction pad onto the barbs of the first leaf, and step b. comprises molding the second friction pad on to the barbs of the second leaf.

19. The method of claim 16, wherein steps a. and b. are carried out in the absence of any separately formed brake pad backing plates.

20. The method of claim 16, further comprising, prior to step a.:
i. stamping a spreader spring blank from a sheet of metal;
ii. gouging the spreader spring blank to form the barbs of the first leaf and the barbs of the second leaf; and
iii. bending the spreader spring blank to form the spreader spring.
